(19) United States
(12) Patent Application Publication
(10) Pub. No.: US 2013/0344385 A1
(43) Pub. Date: Dec. 26, 2013

(54) ELECTRODE ACTIVE MATERIAL, ELECTRODE, AND SECONDARY CELL

(71) Applicants: Honda Giken Kogyo Kabushiki Kaisha, Gijyutu Kenkyusho (JP); MURATA MANUFACTURING CO., LTD., Nagaokakyo-Shi (JP)

(72) Inventors: Tomoaki Onoue, Nagaokakyo-Shi (JP); Masaharu Satoh, Kyoto Nagaokakyo-Shi (JP); Toru Sukigara, Wako-Shi (JP); Hidehisa Mokudai, Wako-Shi (JP)

(73) Assignees: Honda Giken Kogyo Kabushiki Kaisha, Gijyutu Kenkyusho (JP); MURATA MANUFACTURING CO., LTD., Nagaokakyo-Shi (JP)

(21) Appl. No.: 13/974,944

(22) Filed: Aug. 23, 2013

Related U.S. Application Data
(63) Continuation of application No. PCT/JP2012/054424, filed on Feb. 23, 2012.

(30) Foreign Application Priority Data
Feb. 28, 2011 (JP) 2011-042281

(51) Int. Cl. H01M 4/60

(52) U.S. Cl. CPC H01M 4/60
USPC 429/213; 252/500

(57) ABSTRACT

An electrode active material has the general formula (I) or (II) in a constituent unit. In the formulas, X is C or Si; and Y₁ and Y₂, or Y₃ and Y₄ are different substituent groups selected from among S, O, Se, Te, NH, SR₁′R₂′, and SR₃′R₄′. R₁ to R₄ and R₁′ to R₄′ are predetermined substituent groups. Z is CH₂, CF₂, O, S, SO, SO₂, Se, or N—Z′ (where Z′ is a hydrogen atom, an alkyl group, an aryl group, or an oxygen radical). Thereby, high energy density, high output, and excellent cycle characteristics which has a small deterioration of capacity even in repeating charge and discharge are realized.

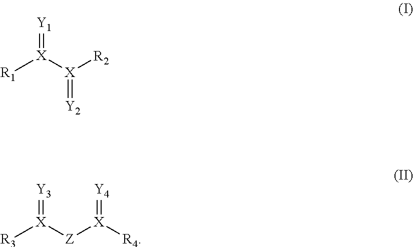

This application is a continuation application of international patent application Serial No. PCT/JP2012/054424 filed 23 Feb. 2012, which published as PCT Publication No. WO2012/117941 on 7 Sep. 2012, which claims benefit of Japan patent application No. 2011-042281 filed 28 Feb. 2011, the entire content of which are incorporated herein by reference.

### TECHNICAL FIELD

The present invention relates to an electrode active material, an electrode and a secondary cell, and more particularly relates to an electrode active material undergoing repeated charging and discharging by using an electrode reaction in the cell, and an electrode and a secondary cell respectively using the electrode active material.

### BACKGROUND ART

With the market expansion of mobile electronic devices such as cellular phones, laptop personal computers and digital cameras, a long-life secondary cell having high energy density able to have a higher output is desired as a cordless power source of these electronic devices.

To respond to such requirements, secondary cells which use alkali metal ions such as lithium ions as a charge carrier, and use an electrochemical reaction associated with giving and receiving of charges of the charge carrier, have been developed. Particularly, a lithium ion secondary cell has high energy density is widely available as a battery for automobile use.

An electrode active material of constituent elements of the secondary cell is a substance directly contributing to the electrode reactions of charging and discharging in the cell, and has a central role in the secondary cell. That is, the electrode reaction in the cell is a reaction which occurs associated with giving and receiving of electrons by applying a voltage to an electrode active material electrically connected to an electrode located in an electrolyte, and the electrode reaction takes place during charge and discharge of the cell. Accordingly, as described above, the electrode active material systemically has a central role in the secondary cell.

In the lithium ion secondary cell, a lithium-containing transition metal oxide is used as a positive electrode active material and a carbon material is used as a negative electrode active material, and charge and discharge is performed by using a lithium ion insertion and detachment reactions of for these electrode active materials.

However, the lithium ion secondary cell has a problem that the charge-discharge rate is restricted since the movement of lithium ions in the positive electrode becomes rate-determining. That is, since the moving rate of lithium ions in the transition metal oxide of the positive electrode in the lithium ion secondary cell is slow as compared with the electrolyte or the negative electrode, the electrode reaction rate in the positive electrode becomes rate-determining to restrict a charge-discharge rate, and consequently there are limitations to an increase in output or shorten of charging time.

In recent years, secondary cells using an organic radical compound, an organic sulfur compound or a quinone compound for the electrode active material are actively researched and developed in order to solve these problems.

For example, the document 1 is known as a prior art document in which the organic radical compound is used for an electrode active material.

The document 1 discloses an active material for a secondary cell which uses a nitroxyl radical compound, an oxyradical compound, and a nitrogen radical compound having a radical on a nitrogen atom.

The organic radical compound can increase the reaction site concentration because unpaired electrons to be reacted exist locally in radical atoms, and thereby realization of a secondary cell having high capacity can be expected. Further, since radicals have a large reaction rate, it is considered that charging can be completed in a short time with the use of an oxidation-reduction reaction of stable radicals.

The document 1 describes Examples in which a nitroxyl radical having high stability as a radical is used, and for example, it is verified that when an electrode layer containing a nitronylnitroxide compound is used as a positive electrode, and a copper foil having lithium bonded thereto is used as a negative electrode to prepare a secondary cell, and charge and discharge are repeated, charging and discharging can be performed over 10 cycles or more.

The documents 2 and 3 are known as prior art documents in which the organic sulfur compound is used for an electrode active material.

The document 2 proposes a novel metal-sulfur type cell in which the organic sulfur compound as a positive electrode material has an S—S bond in a charged state, and the S—S bond is cleaved during discharge of the positive electrode to form an organic sulfur metal salt having metal ions.

In the document 2, a disulfide-based organic compound (hereinafter, referred to as a “disulfide compound”) represented by the general formula (1′) is used as the organic sulfur compound.

R—S—S—R (1′)

Herein, R represents aliphatic organic groups or aromatic organic groups, and the aliphatic organic groups or the aromatic organic groups may be the same or different from each other.

In the disulfide compound, a two-electron reaction can occur, and an S—S bond of the compound is cleaved in a reduced state (discharged state), and thereby an organic thiolate (R—S—) is formed. The organic thiolate forms an S—S bond in an oxidized state (charged state), and returns back to the disulfide compound represented by the general formula (1′). That is, since the disulfide compound forms the S—S bond having small bond energy, a reversible oxidation-reduction reaction occurs with the use of bonding and cleavage by the reaction, and thereby charge and discharge can be performed.

The document 3 proposes an electrode for a cell which has a structural unit represented by the following general formula (2′):

—(NH—CS—CS—NH) (2′)

and includes rubeanic acid or rubeanic acid polymer capable of being bonded with lithium ions.

The rubeanic acid or rubeanic acid polymer containing a dithione structure represented by the general formula (2′) is bonded with lithium ions during reduction, and releases the bonded lithium ions during oxidation. It is possible to perform charge and discharge by using such a reversible oxidation-reduction reaction of rubeanic acid or rubeanic acid polymer.

In the document 3, when the rubeanic acid is used for the positive electrode active material, a two-electron reaction can occur, and a secondary cell having a capacity density of 400 Ah/kg at normal temperature is obtained.

The document 4 is known as a prior art document in which a quinone compound is used for an electrode active material.

The document 4 proposes an electrode active material containing a specific phenanthrenequinone compound having two quinone groups in relative ortho positions.

The specific phenanthrenequinone described in the document 4 initiates a two-electron reaction peculiar to a quinone compound between moving carriers and can generate a reversible oxidation-reduction reaction. Moreover, the oligomerization or polymerization of the specific phenanthrenequinone compound achieves insolubility I an organic solvent without causing a decrease in the number, of reaction electrons due to repulsiveness between electrons. Further, the document 4 indicates that a phenanthrenequinone dimer exhibits two oxidation-reduction voltages (around 2.9 V and around 2.5 V), and that the first discharge capacity reaches 200 Ah/kg.

The document 1: JP No. 2004-207249A (pars. [0278] to [0282]).

The document 2: U.S. Pat. No. 4,833,048 (claim 1, and fifth col. lines 20 to 28).

The document 3: JP No. 2008-147015A (claim 1, par. [0011], FIGS. 3 and 5).

The document 4: JP No. 2008-222559A (claim 4, pars. [0027] and [0033], FIGS. 1 and 3).

### SUMARY OF THE INVENTION

### Problem to be Solved by the Invention

Although an organic radical compound such as a nitroxyl radical compound is used for an electrode active material in the document 1, the charge-discharge reaction is limited to a reaction involving only one electron. When a multi-electron reaction involving two or more electrons occurs in the case of the organic radical compound, radicals lack stability to cause decomposition or the like, and therefore the radicals decay to lose the reversibility of a charge-discharge reaction. Accordingly, the charge-discharge reaction of the organic radical compounds such as in the document 1 is feared to be limited to the one-electron reaction, and it is difficult to realize the multi-electron reaction which can be expected of a high capacity.

In the document 2, although a low molecular disulfide compound involving two electrons is used, since bonding and cleavage with other molecules are repeated in association with the charge-discharge reaction, the cell lacks stability and causes a capacity to deteriorate in case of repetitions of charge and discharge.

Although the two-electron reaction is initiated by using the rubeanic acid or rubeanic acid polymer containing a dithione structure in document 3, the intermolecular interaction in the rubeanic acid polymer is large to interfere with the movement of ions, as a result, a sufficient reaction rate cannot not be achieved. For this reason, it takes much time for charging. Further, since the movement of ions is interfered with as described above, the ratio of the active material which can be used effectively is small, and consequently it is difficult to realize a secondary cell having desired high output.

Since the phenanthrenequinone compound having two quinone groups at relative ortho positions is used for the electrode active material in the document 4, the synthesis of the condensed ring-based phenanthrenequinone compound is difficult and capacity density is small, while stability is excellent.

As described above, it is difficult in the prior art to achieve the multi-electron reaction and the stability to charge-discharge cycles simultaneously even if organic compounds such as organic radical compounds, disulfide compounds and rubeanic acid are used for an electrode active material, and therefore, it is not yet possible to realize a long-life electrode active material having adequately high energy density, high output, and excellent cycle characteristics.

The present invention has been made in view of such a situation, and it is an object of the invention to provide an electrode active material having high energy density, high output, and excellent cycle characteristics with small deterioration of capacity even in repeating charge and discharge, and an electrode and a secondary cell using the electrode active material.

### Means for Solving the Problem

To achieve the aforementioned object, the present inventors have made studies and consequently found that the capacity density of an organic compound having a plurality of atomic groups X═Y, in which each of substituent groups Y is double-bonded to a specific element X, either C or Si, can be increased since the organic compound has a plurality of electrochemically active double bonds. Then, the present inventors have reached the finding that by making substituent groups Y in a plurality of atomic groups X═Y different from each other, a plurality of charge-discharge reactions progress progressively, and thereby a side reaction hardly occurs in an oxidation-reduction reaction, and consequently stability during charging and discharging can be improved.

The present invention has been made based on the above findings, and an electrode active material according to the present invention is an electrode active material which is used as an active material of a secondary cell, repeating charging and discharging by an electrode reaction in the cell, and has a feature of being predominantly composed of an organic compound represented by the general formula:

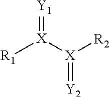

In the formula, X is either C or Si, Y₁ and Y₂ are mutually different substituent groups selected from among S, O, Se, Te, NH and SR₁′R₂′, and R₁, R₂, R₁′, and R₂′ represent any of a hydrogen atom, a hydroxyl group, a substituted or unsubstituted alkyl group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted boryl group, a substituted or unsubstituted stannyl group, a substituted or unsubstituted cyano group, a substituted or unsubstituted nitro group, a substituted or unsubstituted nitroso group, a substituted or unsubstituted amino group, a substituted or unsubstituted imino group, a substituted or unsubstituted carboxyl group, a substituted or unsubstituted alkoxycarbonyl group and a halogen atom, and R₁, R₂, R₁′ and R₂′ may be the same and may be linked together to form a saturated or unsaturated ring.

Further, an electrode active material according to the present invention is an electrode active material which is used as an active material of a secondary cell, repeating charging and discharging by an electrode reaction in the cell, and has a feature of being predominantly composed of an organic compound represented by the general formula:

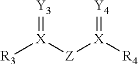

In the formula, X is either C or Si, Y₃ and Y₄ are mutually different substituent groups selected from among S, O, Se, Te, NH and SR₃′R₄′, and R₃, R₄, R₃′, and R₄′ represent any of a hydrogen atom, a hydroxyl group, a substituted or unsubstituted alkyl group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted boryl group, a substituted or unsubstituted stannyl group, a substituted or unsubstituted cyano group, a substituted or unsubstituted nitro group, a substituted or unsubstituted nitroso group, a substituted or unsubstituted amino group, a substituted or unsubstituted imino group, a substituted or unsubstituted carboxyl group, a substituted or unsubstituted alkoxycarbonyl group and a halogen atom, and R₃, R₄, R₃′ and R₄′ may be the same and may be linked together to form a saturated or unsaturated ring, and Z represents at least one of CH₂, CF₂, O, S, SO₂, Se, and N—Z′ (in which Z′ represents at least one selected from among one or more hydrogen atoms, alkyl groups, aryl groups and oxygen radicals, or combinations thereof), or combinations thereof.

An electrode according to the present invention has a feature of comprising the electrode active material according to any of the above-electrode active materials and a conductive material.

Further, a secondary cell according to the present invention has a feature in that the electrode active material according to any of the above electrode active materials is contained in any one of a reaction starting material, a reaction product and an intermediate product in at least a discharge reaction of an electrode reaction in the cell.

Further, the secondary cell according to the present invention comprises a positive electrode, a negative electrode and an electrolyte, and has a feature in that the positive electrode comprises the electrode active material according to any of the above electrode active materials.

### Effects of the Invention

In accordance with the electrode active material of the present invention, the electrode active material is predominantly composed of an organic compound containing, in a constituent unit, a plurality of atomic groups X═Y in which each of substituent groups Y is double-bonded to a specific element X, either C or Si, and the substituent groups Y are different from each other, and therefore a plurality of charge-discharge reactions progress progressively. Thereby, a side reaction hardly occurs in an oxidation-reduction reaction, and consequently stability during charging and discharging can be improved. Furthermore, since a plurality of double-bonds which are electrochemically active and rich in reactivity with cations such as lithium ions are introduced, the charge-discharge efficiency is high and capacity density can be increased. As a result, an electrode active material with high energy density, in which stability during charging and discharging is improved, can be obtained.

Further, it is preferred to interpose a predetermined linking group Z between the atomic group X═Y₃ and the atomic group X═Y₄ having different substituent groups Y. Thereby, intermolecular interaction between atomic groups is weakened, and ions are easily moved during the charge-discharge reaction. Accordingly, the charge-discharge reaction progresses smoothly to enable charging in a short time. Since the charge-discharge reaction progresses smoothly, as described above, the proportion of the electrode active material which can be effectively used is increased to enable to discharge at high output.

Further, since the electrode of the present invention contains the electrode active material according to any of the above-electrode active materials and a conductive material, it is possible to attain an electrode in which charge-discharge efficiency is high, charge can be performed in a short time, and an increase in output can be realized.

Moreover, since the electrode active material according to any of the above-electrode active materials in accordance with the secondary cell of the present invention is contained in any one of a reaction starting material, a reaction product and an intermediate product in at least a discharge reaction of an electrode reaction in the cell, it becomes possible to attain a long-life secondary cell which has high energy density, can be charged quickly and discharged at high output, and has excellent cycle characteristics and stable cell characteristics which has a small deterioration of capacity even in repeating charge and discharge.

Furthermore, since the electrode active material is predominantly composed of the above-mentioned organic compound, it is possible to attain a secondary cell in which an environmental burden is low and its safety is taken into consideration.

The above and other objects, features, and advantages of the invention will become more apparent from the following description.

### BRIEF DESCRIPTION OF THE DRAWING

FIG. 1 is a sectional view showing an embodiment of a coin type cell as a secondary cell according to the present invention.

### MODE FOR CARRYING OUT THE INVENTION

Next, the mode for carrying out the invention will be described in detail.

The electrode active material of the present invention is predominantly composed of an organic compound containing, in a constituent unit, a plurality of atomic groups X═Y in which each of substituent groups Y is double-bonded to a specific element X, either C or Si, and the substituent groups Y are different from each other. Thereby, it becomes possible to attain a long-life secondary cell which has high energy density and high charge-discharge efficiency, can be discharged at high output, and has excellent cycle characteristics and stable cell characteristics with small deterioration of capacity even in repeating charge and discharge.

In the organic compound predominantly including the above-electrode active material, a plurality of charge-discharge reactions progress progressively because adjacent substituent groups Y contributing to a reaction among a plurality of atomic groups X═Y are different from each other, so that side reactions hardly occur during an oxidation-reduction reaction, consequently stability during charging and discharging can be improved.

Furthermore, since a plurality of electrochemically active double-bonds is introduced, it is possible to attain an electrode active material which is rich in reactivity with cations such as lithium ions, and has high charge-discharge efficiency and high capacity density.

Accordingly, a secondary cell using such an electrode active material, has stability during charging and discharging improved, and it becomes possible to attain a long-life secondary cell which has a high energy density, can be discharged at high output, and has excellent cycle characteristics and stable cell characteristics which has a small deterioration of capacity even in repeating charge and discharge.

Examples of the organic compound (first embodiment) containing a plurality of atomic groups X═Y having different substituent groups Y in a constituent unit may include compounds represented by the general formula (1).

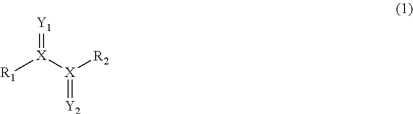

Herein, X is either C or Si, and Y₁ and Y₂ are different substituent groups selected from among S, O, Se, Te, NH and SR₁′R₂′.

R₁, R₂, R₁′, and R₂′ represent at least any of a hydrogen atom, a hydroxyl group, a substituted or unsubstituted alkyl group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted boryl group, a substituted or unsubstituted stannyl group, a substituted or unsubstituted cyano group, a substituted or unsubstituted nitro group, a substituted or unsubstituted nitroso group, a substituted or unsubstituted amino group, a substituted or unsubstituted imino group, a substituted or unsubstituted carboxyl group, a substituted or unsubstituted alkoxycarbonyl group and a halogen atom. Moreover, R₁, R₂, R₁′ and R₂′ may be the same and may be linked together to form a saturated or unsaturated ring.

The following reaction formulas (1-I) to (1-III) show an example of the charge-discharge reaction which is predicted when the organic compound represented by the general formula (1) is used for an electrode active material and Li is used for a cation of an electrolyte salt.

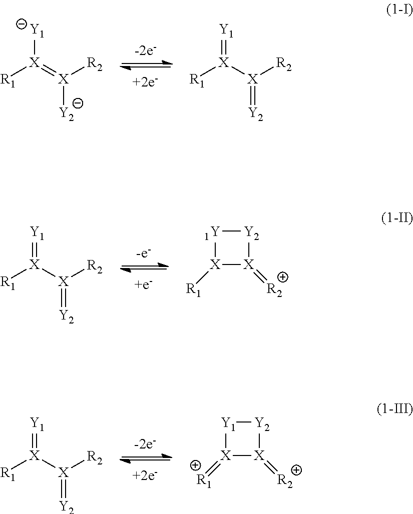

The above-electrode active material produces a complex salt associated with the electrode reaction in the cell, and three oxidation-reduction reactions represented by the formulas (1-I), (1-II) and (1-III) progress during charging and discharging.

As described above, by having an atomic group X═Y₁ and an atomic group X═Y₂ having different substituent groups in constituent units in the present embodiment, a plurality of charge-discharge reactions progress progressively, side reactions hardly occur during an oxidation-reduction reaction, and as a result, it becomes possible to attain an electrode active material having high energy density and excellent stability.

Examples of compounds falling within the category of the above-mentioned general formula (1) may include compounds represented by the chemical formulas (1a) to (1c).

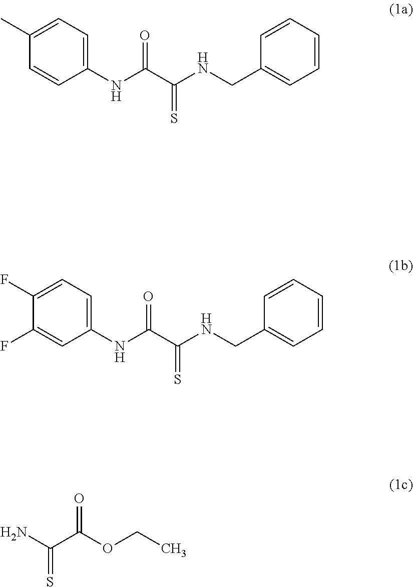

Although the 1 molecular weight of an organic compound constituting the electrode active material is not particularly limited, a high molecular organic compound is preferred since a low molecular organic compound having a small molecular weight might be easily dissolved in an electrolyte. However, the occurrence of the desired effect of the present invention depends on the reactivity of the atomic group X═Y₁ and the atomic group X═Y₂, and therefore if a portion other than these atomic groups is large, the capacity capable of being stored per a unit mass, namely capacity density, is small.

Examples of a second embodiment of the organic compound may include compounds represented by the general formula (2), which is formed by interposing a linking group Z between the atomic group X═Y₃ and the atomic group X═Y₄ having different substituent groups Y.

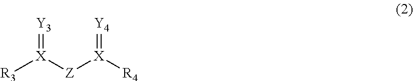

Y₃ and Y₄ represent mutually different substituent groups selected from among S, O, Se, Te, NH and SR₃′R₄′ as with Y₁ and Y₂.

As with R₁, R₂, R₁′ and R₂′, R₃, R₄, R₃′, and R₄′ represent any of a hydrogen atom, a hydroxyl group, a substituted or unsubstituted alkyl group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted boryl group, a substituted or unsubstituted stannyl group, a substituted or unsubstituted cyano group, a substituted or unsubstituted nitro group, a substituted or unsubstituted nitroso group, a substituted or unsubstituted amino group, a substituted or unsubstituted imino group, a substituted or unsubstituted carboxyl group, a substituted or unsubstituted alkoxycarbonyl group and a halogen atom. Moreover, R₃, R₄, R₃′ and R₄′ may be the same and may be linked together to form a saturated or unsaturated ring.

Further, Z represents at least one of CH₂, CF₂, O, S, SO₂, Se, and N—Z′ (where Z′ represents at least one of hydrogen atoms, alkyl groups, aryl groups and oxygen radicals, or combinations thereof), or combinations thereof.

In the second embodiment described above, in addition to the effect exerted by the first embodiment, the intermolecular interaction between atomic groups is further weakened, the movement of ions during the charge-discharge reaction is accelerated, and the charge-discharge reaction progresses more smoothly by interposing a linking group Z between the atomic group X═Y₃ and the atomic group X═Y₄, and therefore it becomes possible to further increase output.

The following chemical reaction formulas (2-I) and (2-II) show an example of the charge-discharge reaction which is predicted when the organic compound represented by the general formula (2) is used for an electrode active material and Li is used for a cation of an electrolyte salt.

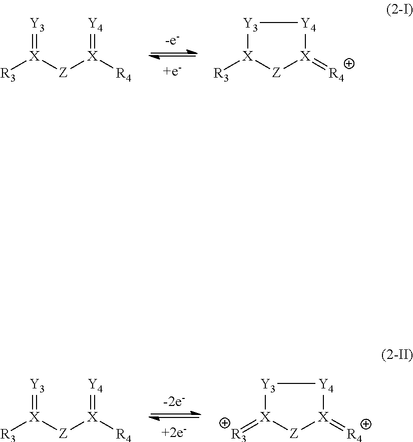

The above-electrode active material produces a complex salt associated with the electrode reaction in the cell, and two oxidation-reduction reactions represented by the formulas (2-I) and (2-II) progress during charging and discharging.

In the present embodiment described above, the charge-discharge reactions progress progressively by the atomic group X═Y₃ and the atomic group X═Y₄ having mutually different substituent groups, and thereby side reactions hardly occur during an oxidation-reduction reaction. Consequently, it becomes possible to attain a secondary cell having high energy density and excellent stability.

Examples of compounds falling within the category of the general formulas (2) may include compounds represented by the chemical formulas (2a) to (2d).

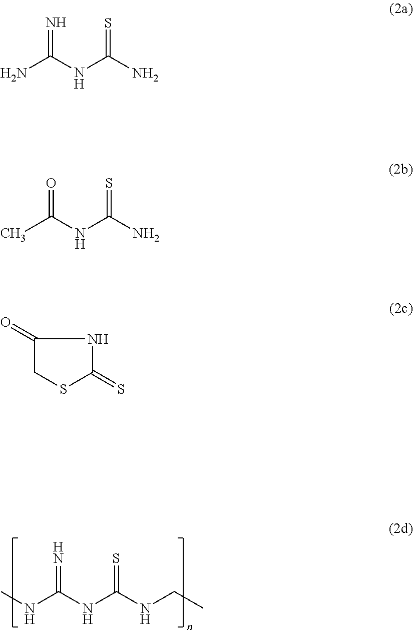

Although a molecular weight of an organic compound constituting the electrode active material is not particularly limited, a high molecular organic compound is preferred since a low molecular organic compound having a small molecular weight might be easily dissolved in an electrolyte, as in the first embodiment. However, the occurrence of the desired effect of the present invention depends on the reactivity of the atomic group X═Y₃ and the atomic group X═Y₄, and therefore if a portion other than these atomic groups is large, the capacity capable of being stored per a unit mass, namely capacity density, is small.

When the organic compound is used as a polymer, the molecular weight and a molecular weight distribution are not particularly limited.

Next, a secondary cell using the electrode active material will be described in detail.

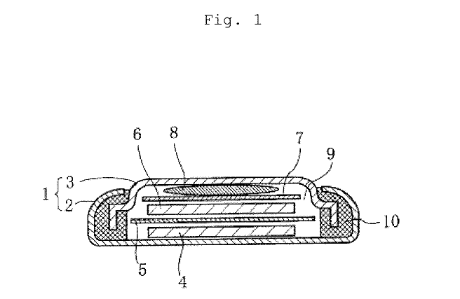

FIG. 1 is a sectional view showing a coin type secondary cell as an embodiment of a secondary cell according to the present invention, and in the present embodiment, the electrode active material of the invention is used for a positive electrode.

A cell can 1 has a positive electrode case 2 and a negative electrode case 3, and the positive electrode case 2 and the negative electrode case 3 are both formed into the shape of a disc-like thin plate. A positive electrode 4, which is obtained by forming a mixture containing a positive electrode active material and a conductive aid (conductive material) into a sheet shape, is arranged at a bottom center of the positive electrode case 2 constituting a positive electrode current collector. A separator 5 formed of a porous sheet or film such as microporous membrane, woven fabric or nonwoven fabric is laminated on the positive electrode 4, and a negative electrode 6 is laminated on the separator 5. As a material of the negative electrode 6, for example, a stainless steel foil or copper foil having a lithium metal foil overlaid thereon, and a copper foil having a lithium absorption material such as graphite or hard carbon applied thereto, can be used. A negative electrode current collector 7 made of metal is laminated on the negative electrode 6, and a metallic spring 8 is placed on the negative electrode current collector 7. An electrolyte 9 is filled into an internal space, and the negative electrode case 3 is attached fixedly to the positive electrode case 2 against a biasing force of the metallic spring 8, and these cases are sealed with a gasket 10 interposed therebetween.

Next, an example of a method of manufacturing the secondary cell will be described in detail.

First, an electrode active material is formed into an electrode shape. For example, the electrode active material is mixed with a conductive aid and a binder, a solvent is then added to the resulting mixture to form slurry, and the slurry is applied onto a positive electrode current collector by an arbitrary coating method and dried to form a positive electrode.

The conductive aid is not particularly limited, and for example, carbonaceous fine particles such as graphite, carbon black, and acetylene black; carbon fibers such as vapor grown carbon fibers, carbon nanotubes, and carbon nanohorns; and conductive polymers such as polyaniline, polypyrrole, polythiophene, polyacetylene, and polyacene can be used. Further, two or more kinds of the conductive aids can be mixed for use. The content of the conductive aid in the positive electrode 4 is preferably 10 to 80% by mass.

Also, the binder is not particularly limited, and various resins such as polyethylene, polyvinylidene fluoride, polyhexafluoropropylene, polytetrafluoroethylene, polyethylene oxide, and carboxymethyl cellulose can be used.

Moreover, the solvent is not particularly limited, and for example, basic solvents such as dimethylsulfoxide, dimethylformamide, 1-methyl-2-pyrrolidone, propylene carbonate, diethyl carbonate, dimethyl carbonate, and γ-butyrolactone; non-aqueous solvents such as acetonitrile, tetrahydrofuran, nitrobenzene, and acetone; protic solvents such as methanol and ethanol; and water can be used.

The kind of the organic solvent, mixing ratio of the organic compound and the organic solvent, and the kind and addition amount of an additive, and the like can be arbitrarily set in consideration of required characteristics of the secondary cell, productivity and the like. Then, the positive electrode 4 is impregnated with the electrolyte 9 to allow the electrolyte 9 to penetrate into the positive electrode 4, and thereafter, the positive electrode 4 is placed at a bottom center of the positive electrode case 2 constituting the positive electrode current collector. Then, the separator 5 impregnated with the electrolyte 9 is laminated on the positive electrode 4, and the negative electrode 6 and the negative electrode current collector 7 are laminated in turn, and thereafter, the electrolyte 9 is injected into an internal space. Then, the metallic spring 8 is placed on the negative electrode current collector 7, and the gasket 10 is arranged at a periphery, and the negative electrode case 3 is attached fixedly to the positive electrode case 2, and these cases are externally sealed with a caulking machine to prepare a coin type secondary cell.

In addition, the electrolyte 9 is interposed between the positive electrode 4 and the negative electrode 6, an opposed electrode of the positive electrode 4, to perform charge carrier transport between both electrodes, and as such an electrolyte 9, a material having an ion conductivity of 10⁻⁵ to 10⁻¹ S/cm at room temperature can be used, and for example, an electrolytic solution obtained by dissolving an electrolyte salt in an organic solvent can be used.

Herein, as the electrolyte salt, for example, LiPF₆, LiClO₄, LiBF₄, LiCF₃SO₃, LiN(CF₃SO₂)₂, LiN(C₂F₅SO₂)₂, LiC(CF₃SO₂)₃, LiC(C₂F₅SO₂)₃ and the like can be used.

Further, as the organic solvent, ethylene carbonate, propylene carbonate, dimethyl carbonate, diethyl carbonate, methylethyl carbonate, γ-butyrolactone, tetrahydrofuran, dioxolane, sulfolane, dimethylformamide, dimethylacetamide, 1-methyl-2-pyrrolidone and the like can be used.

Further, a solid electrolyte may be used for the electrolyte 9. Examples of a polymer compound used for the solid electrolyte may include vinylidene fluoride-based polymers such as polyvinylidene fluoride, vinylidene fluoride-hexafluoropropylene copolymer, vinylidene fluoride-ethylene copolymer, vinylidene fluoride-monofluoroethylene copolymer, vinylidene fluoride-trifluoroethylene copolymer, vinylidene fluoride-tetrafluoroethylene copolymer, and vinylidene fluoride-hexafluoropropylene-tetrafluoroethylene terpolymer; acrylonitrile-based polymers such as acrylonitrile-methyl methacrylate copolymer, acrylonitrile-methyl acrylate copolymer, acrylonitrile-ethyl methacrylate copolymer, acrylonitrile-ethyl acrylate copolymer, acrylonitrile-methacrylic acid copolymer, acrylonitrile-acrylic acid copolymer, and acrylonitrile-vinyl acetate copolymer; polyethylene oxide, ethylene oxide-propylene oxide copolymer, and polymers such as acrylate and methacrylate thereof, and the like. Also, gelated mixtures of these polymer compounds and an electrolytic solution may be used as the electrolyte 9, or only a polymer compound containing an electrolyte salt may be used as it is for the electrolyte 9.

Since the electrode of the present invention contains the electrode active material and the conductive material described above, it has high charge-discharge efficiency and can be charged in a short time, and an increase in output can be realized.

Further, while the electrode active material of the secondary cell has a varying structure and state depending on the charge state, discharge state or intermediate state thereof since the electrode active material is reversibly oxidized or reduced by charging and discharging, in the present embodiment, the electrode active material is contained in any one of a reaction starting material (a substance initiating a chemical reaction in an electrode reaction in the cell), a reaction product (a substance produced as a result of a chemical reaction), and an intermediate product in at least a discharge reaction. As a result, it becomes possible to attain a long-life secondary cell which has high energy density, can be charged quickly and discharged at high output, and has excellent cycle characteristics and stable cell characteristics with small deterioration of capacity even in repeating charge and discharge.

Further, the discharge reaction in the secondary cell of the present invention has at least two discharge voltages, and thereby, a secondary cell having high capacity density across a plurality of voltages can be realized.

Furthermore, since the electrode active material is predominantly composed of an organic compound, it is possible to attain a secondary cell in which the environmental burden is low and its safety is taken into consideration.

The present invention is not limited to the above-mentioned embodiments, and various variations may be made without departing from the gist of the invention. For example, with respect to the organic compound predominantly constituting the electrode active material, each of the chemical formulas (1a) to (1c) and (2a) to (2d) listed above is just an example of the chemical formulas of the organic compound, and the chemical formula is not limited to these formulas. That is, when the organic compound contains, in a constituent unit, a plurality of atomic groups X═Y in which each of substituent groups Y is double-bonded to a specific element X, either C or Si, and the substituent groups Y are different from each other, an electrode reaction in the cell progresses in stages as with the above reaction formulas (1-I) to (1-III) or (2-I) to (2-II), and therefore stability of a charge-discharge reaction is improved without causing a side reaction, and it becomes possible to attain a desired secondary cell having high energy density and excellent stability.

Further, in the present embodiment, a coin type secondary cell has been described, but it is needless to say that the shape of the cell is not particularly limited, and the present invention can also be applied to a cylindrical cell, a prismatic cell, a sheet-shaped cell, and the like. Also, the casing method is not also particularly limited, and a metal case, a molded resin, an aluminum laminate film or the like may be used.

Further, the electrode active material in the present embodiment is used for the positive electrode active material, but the electrode active material is effectively used for the negative electrode active material.

Next, Examples of the present invention will be specifically described.

In addition, each of Examples shown below is just an example, and the present invention is not limited to Examples below.

### EXAMPLES

### Example 1

### Preparation of Secondary Cell

2-Benzylamino-N-(4-methylphenyl)-2-thioxoacetamide represented by the chemical formula (1a) (hereinafter, referred to as a “compound A”) was prepared.

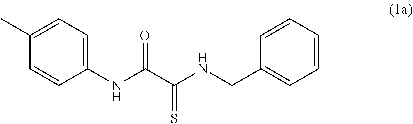 [SMILES: Cc1ccc(NC(=O)C(=S)NCc2ccccc2)cc1]

Then, 100 mg of the compound A as a positive electrode active material (electrode active material), 600 mg of a graphite powder as a conductive aid, and 100 mg of polytetrafluoroethylene as a binder were respectively weighed, and these components were kneaded while being uniformly mixed to prepare a mixture. Next, the mixture was pressure-formed to obtain a sheet-like member having a thickness of about 150 μm. Thereafter, the sheet-like member was dried at 70° C. for 1 hour in vacuum, and then punched out into a round shape with a diameter of 12 mm to prepare a positive electrode containing the compound A. Next, the positive electrode was impregnated with an electrolytic solution to allow the electrolytic solution to penetrate into cavities in the positive electrode. As the electrolytic solution, a mixed solution obtained by dissolving LiPF₆ (electrolyte salt) in ethylene carbonate/diethyl carbonate of an organic solvent in such a way that a molar concentration of LiPF₆ was 1.0 mol/L was used. In addition, the mixing ratio between ethylene carbonate and diethyl carbonate was 30:70 by vol %.

Next, the positive electrode was placed on a positive electrode current collector, and further a separator having a thickness of 20 μm, which was made of a polypropylene porous film impregnated with the electrolytic solution, was laminated on the positive electrode, and further a negative electrode obtained by bonding lithium to both surfaces of a stainless steel current collector was laminated on the separator. Then, a metallic spring was placed on the current collector, and a negative electrode case was joined to a positive electrode case with a gasket arranged at a periphery, and these cases were externally sealed with a caulking machine to prepare a hermetically sealed coin type cell having the compound A as a positive electrode active material and metal lithium as a negative electrode active material.

### Check of Operation of Secondary Cell

The coin type cell thus prepared was charged at a constant current of 0.1 mA until the voltage reached 4.2 V, and thereafter, was discharged at a constant current of 0.1 mA until the voltage reached 1.5 V. Consequently, the cell was verified to be a secondary cell having a discharge capacity of 0.21 mAh, which had a plurality of voltage plateau at a charge-discharge voltage of 1.8 to 3.8 V.

Thereafter, a cycle of charge and discharge was repeated 10 times in a range of 1.5 to 4.2 V. The voltage was 50% or more of the initial voltage even after 10 cycles of charge and discharge, and therefore the cell was verified to be a long-cycle life secondary cell which had a small deterioration of capacity even in repeating charge and discharge.

### Example 2

Ethyl thiooxamate represented by the chemical formula (1c) (hereinafter, referred to as a “compound B”) was prepared.

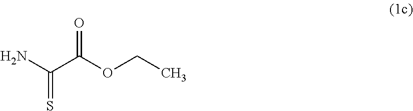

Then, a coin type cell was prepared in the same manner as in Example 1 except for using the compound B for a positive electrode active material instead of the compound A in Example 1.

### Check of Operation of Secondary Cell

The coin type cell was charged at a constant current of 0.1 mA until the voltage reached 4.2 V, and thereafter, was discharged at a constant current of 0.1 mA until the voltage reached 1.5 V. Consequently, the cell was verified to be a secondary cell having a discharge capacity of 1.17 mAh, which had a plurality of voltage plateau at a charge-discharge voltage of 2.0 to 3.0 V.

Thereafter, a cycle of charge and discharge was repeated 10 times in a range of 1.5 to 4.2 V. The voltage was 50% or more of the initial voltage even after 10 cycles of charge and discharge, and therefore the cell was verified to be a long-cycle life secondary cell which had a small deterioration of capacity even in repeating charge and discharge.

### Example 3

### Preparation of Secondary Cell

Guanylthiourea represented by the chemical formula (2a) (hereinafter, referred to as a “compound C”) was prepared.

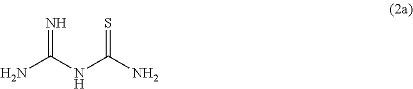

Then, a coin type cell was prepared in the same manner as in Example 1 except for using the compound C for a positive electrode active material instead of the compound A in Example 1.

### Check of Operation of Secondary Cell

The coin type cell was charged at a constant current of 0.1 mA until the voltage reached 4.2 V, and thereafter, was discharged at a constant current of 0.1 mA until the voltage reached 1.5 V. Consequently, the cell was verified to be a secondary cell having a discharge capacity of 0.61 mAh, which had a plurality of voltage plateau at a charge-discharge voltage of 2.0 to 3.0 V.

Thereafter, a cycle of charge and discharge was repeated 10 times in a range of 1.5 to 4.2 V. The voltage was 50% or more of the initial voltage even after 10 cycles of charge and discharge, and therefore the cell was verified to be a long-cycle life secondary cell which had a small deterioration of capacity even in repeating charge and discharge.

### Example 4

### Preparation of Secondary Cell

1-Acetyl-2-thiourea represented by the chemical formula (2b) (hereinafter, referred to as a “compound D”) was prepared.

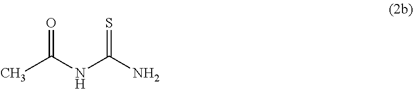

Then, a coin type cell was prepared in the same manner as in Example 1 except for using the compound D for a positive electrode active material instead of the compound A in Example 1.

### Check of Operation of Secondary Cell

The coin type cell was charged at a constant current of 0.1 mA until the voltage reached 4.2 V, and thereafter, was discharged at a constant current of 0.1 mA until the voltage reached 1.5 V. Consequently, the cell was verified to be a secondary cell having a discharge capacity of 0.90 mAh, which had a plurality of voltage plateau at a charge-discharge voltage of 1.8 to 3.0 V.

Thereafter, a cycle of charge and discharge was repeated 10 times in a range of 1.5 to 4.2 V. The voltage was 50% or more of the initial voltage even after 10 cycles of charge and discharge, and therefore the cell was verified to be a long-cycle life secondary cell which had a small deterioration of capacity even in repeating charge and discharge.

### Example 5

### Synthesis of Organic Compound

A formaldehyde condensate of guanylthiourea (hereinafter, referred to as a “compound E”) was synthesized according to the following synthesis scheme (A).

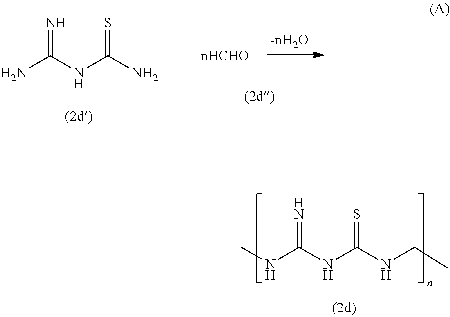

First, 3.5 g of guanylthiourea was dissolved in 50 mL of pure water, and to the resulting solution, 10 ml of a 37% formaldehyde solution was added dropwise while stirring the mixture at 80° C. Stirring of the mixture was continued for 12 hours after dropwise addition to perform a condensation reaction between guanylthiourea (2d′) and formaldehyde (2d″). A guanylthiourea-formaldehyde condensate (2d) thus obtained was separated by filtration, washed with pure water, and then dried to obtain a brown solid of the compound E.

### Preparation of Secondary Cell

A coin type cell was prepared in the same manner as in Example 1 except for weighing 300 mg of the compound E and using the compound E for a positive electrode active material instead of the compound A in Example 1.

### Check of Operation of Secondary Cell

The coin type cell was charged at a constant current of 0.1 mA until the voltage reached 4.2 V, and thereafter, was discharged at a constant current of 0.1 mA until the voltage reached 1.5 V. Consequently, the cell was verified to be a secondary cell having a discharge capacity of 0.30 mAh, which had a plurality of voltage plateau at a charge-discharge voltage of 2.0 to 3.0 V.

Thereafter, a cycle of charge and discharge was repeated 10 times in a range of 1.5 to 4.2 V. The voltage was 50% or more of the initial voltage even after 10 cycles of charge and discharge, and therefore the cell was verified to be a long-cycle life secondary cell which had a small deterioration of capacity even in repeating charge and discharge.

### INDUSTRIAL APPLICABILITY

A secondary cell in which energy density is high, output is high, and cycle characteristics are good and stable, such as a small decline in capacity during repeated charge and discharge, is realized.

### DESCRIPTION OF REFERENCE NUMERALS

4 Positive electrode

6 Negative electrode

9 Electrolyte

1. A secondary cell comprising a positive electrode, a negative electrode, and an electrolyte, in which at least one of said electrodes and electrolyte comprises an organic compound containing at least one unit represented by the general formula: 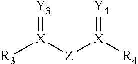
wherein each individual X is either C or Si; Y₃ and Y₄ in each individual unit are different substituent groups selected from the group consisting of S, O, Se, Te, NH and SR₃′R₄′; R₃, R₄, R₃′, and R₄′ represent at least one member of the group consisting of a hydrogen atom, a hydroxyl group, a substituted or unsubstituted alkyl group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted boryl group, a substituted or unsubstituted stannyl group, a substituted or unsubstituted cyano group, a substituted or unsubstituted nitro group, a substituted or unsubstituted nitroso group, a substituted or unsubstituted amino group, a substituted or unsubstituted imino group, a substituted or unsubstituted carboxyl group, a substituted or unsubstituted alkoxycarbonyl group and a halogen atom, and R₃, R₄, R₃′ and R₄′ may be the same and may be linked together to form a saturated or unsaturated ring; and Z represents a bond or at least one member selected from the group consisting of CH₂, CF₂, O, S, SO₂, Se, and N—Z′ in which Z′ represents at least one member selected from the group consisting of hydrogen atoms, alkyl groups, aryl groups and oxygen radicals, or combinations thereof; or combinations thereof.

2. A secondary cell according to claim 1 wherein Z is a bond or >NH; Y₃ and Y₄ are individually selected from the group consisting of O, S, and NH; and R₃ and R₄ are individually selected from the group consisting of NH₃, CH₃, OCH₃, NHCH₃, and NHC₆H₅.

3. A secondary cell according to claim 1 in which Z is a bond.

4. A secondary cell according to claim 3 in which the electrode active material is 2-benzylamino-N-(4-methylphenyl)-2-thioxoacetamide or ethyl thiooxamate.

5. A secondary cell according to claim 1 in which Z is not a bond.

6. A secondary cell according to claim 5 in which the electrode active material is a compound of the formula 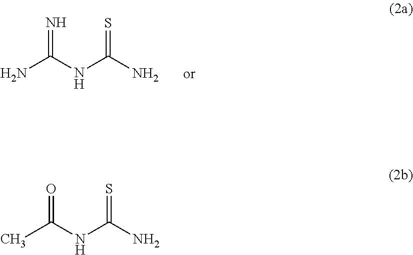
or a guanylthiorea-formaldehyde condensate.

7. A secondary cell according to claim 6 in which said positive electrode comprises the electrode active material.

8. A secondary cell according to claim 5 in which said positive electrode comprises the electrode active material.

9. A secondary cell according to claim 4 in which said positive electrode comprises the electrode active material.

10. A secondary cell according to claim 3 in which said positive electrode comprises the electrode active material.

11. A secondary cell according to claim 2 in which said positive electrode comprises the electrode active material.

12. A secondary cell according to claim 1 in which said positive electrode comprises the electrode active material.

13. An electrode comprising an electrode active material and a conductive material, wherein said electrode active material comprises an organic compound containing at least one unit represented by the general formula: 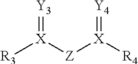
wherein each individual X is either C or Si; Y₃ and Y₄ in each individual unit are different substituent groups selected from the group consisting of S, O, Se, Te, NH and SR₃′R₄′; R₃, R₄, R₃′, and R₄′ represent at least one member of the group consisting of a hydrogen atom, a hydroxyl group, a substituted or unsubstituted alkyl group, a substituted or unsubstituted aryl group, a substituted or unsubstituted aralkyl group, a substituted or unsubstituted cycloalkyl group, a substituted or unsubstituted alkoxyl group, a substituted or unsubstituted alkenyl group, a substituted or unsubstituted aryloxy group, a substituted or unsubstituted arylamino group, a substituted or unsubstituted alkylamino group, a substituted or unsubstituted thioaryl group, a substituted or unsubstituted thioalkyl group, a substituted or unsubstituted heterocyclic group, a substituted or unsubstituted formyl group, a substituted or unsubstituted silyl group, a substituted or unsubstituted boryl group, a substituted or unsubstituted stannyl group, a substituted or unsubstituted cyano group, a substituted or unsubstituted nitro group, a substituted or unsubstituted nitroso group, a substituted or unsubstituted amino group, a substituted or unsubstituted imino group, a substituted or unsubstituted carboxyl group, a substituted or unsubstituted alkoxycarbonyl group and a halogen atom, and R₃, R₄, R₃′ and R₄′ may be the same and may be linked together to form a saturated or unsaturated ring; and Z represents a bond or at least one member selected from the group consisting of CH₂, CF₂, O, S, SO₂, Se, and N—Z′ in which Z′ represents at least one member selected from the group consisting of hydrogen atoms, alkyl groups, aryl groups and oxygen radicals, or combinations thereof; or combinations thereof.

14. An electrode according to claim 13 wherein Z is a bond or >NH; Y₃ and Y₄ are individually selected from the group consisting of O, S, and NH; and R₃ and R₄ are individually selected from the group consisting of NH₃, CH₃, OCH₃, NHCH₃, and NHC₆H₅.

15. An electrode according to claim 13 in which Z is a bond.

16. A electrode according to claim 15 in which the electrode active material is 2-benzylamino-N-(4-methylphenyl)-2-thioxoacetamide or ethyl thiooxamate.

17. An electrode according to claim 13 in which Z is not a bond.

18. A electrode according to claim 17 in which the electrode active material is a compound of the formula 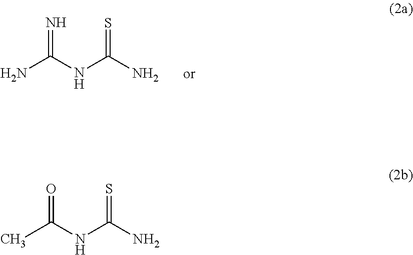
or a guanylthiorea-formaldehyde condensate.
